(19) United States
(12) Patent Application Publication
(10) Pub. No.: US 2023/0185446 A1
(43) Pub. Date: Jun. 15, 2023

(54) INFORMATION PROCESSING APPARATUS AND CONTROL METHOD

(71) Applicant: Lenovo (Singapore) Pte. Ltd., Singapore (SG)

(72) Inventors: Ryohta Nomura, Kanagawa (JP); Tran Minh Khuong Vu, Kanagawa (JP)

(73) Assignee: Lenovo (Singapore) Pte. Ltd., Singapore (SG)

(21) Appl. No.: 18/046,940

(22) Filed: Oct. 17, 2022

(30) Foreign Application Priority Data
Dec. 15, 2021 (JP) 2021-203294

(51) Int. Cl. G06F 3/04883; G06V 30/32; G06T 7/70; G06T 7/60

(52) U.S. Cl. CPC G06F 3/04883; G06V 30/32; G06T 7/70; G06T 7/60

(57) ABSTRACT

An information processing apparatus and a control method capable of properly grasping the character size and drawing position for free-size or free-position handwriting input are provided. The information processing apparatus includes an input unit capable of detecting handwriting input, a display unit capable of displaying a trajectory of the handwriting input, a display control unit configured to display a trajectory of the handwriting input detected by the input unit on the display unit, a text recognition unit configured to recognize text on the basis of the handwriting input detected by the input unit, and a character size estimation unit configured to obtain a size of drawing of each character in the text, estimate a user-intended character size of the text on the basis of information about a standard height of each character, and generate information indicating the character size and a drawing position.

### CROSS-REFERENCE TO RELATED APPLICATIONS

This application claims priority to Japanese Patent Application No. 2021-203294 filed Dec. 15, 2021, the contents of which are hereby incorporated herein by reference in their entirety.

### TECHNICAL FIELD

The present invention relates to an information processing apparatus and a control method.

### BACKGROUND

In recent years, in information processing apparatuses such as tablet terminals, a technology called drawing gestures is known in which editing operations such as erasing characters, separating characters, breaking lines, and the like are performed by making specific handwriting input of vertical line and the like, for example, on handwritten input characters, words, sentences, and paragraphs (see, e.g., Japanese Translation of PCT International Application Publication No. 2019-507915).

### SUMMARY

However, the conventional technology described above assumes handwriting input at a designated size and position (e.g., between ruled lines displayed on the screen), so in the case of free-size and free-position handwriting input without ruled lines, it was difficult to properly grasp the size and drawing position of the characters due to the variation in character size. Therefore, there was a possibility of false detection when, for example, performing an operation using the drawing gesture as described above.

One or more embodiments of the invention provide an information processing apparatus and a control method capable of properly grasping the character size and drawing position for free-size or free-position handwriting input.

One or more embodiments relate to an information processing apparatus which includes: an input unit capable of detecting handwriting input; a display unit capable of displaying a trajectory of the handwriting input; a display control unit configured to display a trajectory of the handwriting input detected by the input unit on the display unit; a text recognition unit configured to recognize text on the basis of the handwriting input detected by the input unit; and a character size estimation unit configured to obtain a size of drawing of each character in the text, estimate a character size of the text intended by a user on the basis of information about a standard height of each character, and generate information indicating the character size and a drawing position.

The information processing apparatus according to one or more embodiments may further include: a gesture determination unit configured to determine that a trajectory of the handwriting input newly detected by the input unit is a drawing gesture to edit the text, on the basis of a range of the text set in accordance with the information indicating the character size and the drawing position generated by the character size estimation unit; and a gesture processing unit configured to perform, on the text, editing processing according to the drawing gesture determined by the gesture determination unit.

In the information processing apparatus according to one or more embodiments, the gesture determination unit may determine that the trajectory of the newly detected handwriting input is the drawing gesture in response to the trajectory of the newly detected handwriting input exceeding the range of the text.

In the information processing apparatus according to one or more embodiments, the range of the text may include an upper limit line and a lower limit line in a vertical direction of the text.

In the information processing apparatus according to one or more embodiments, the character size estimation unit may set an average line of upper limit of the character size of each character to the upper limit line, and set an average line of lower limit of the character size of each character to the lower limit line.

In the information processing apparatus according to one or more embodiments, the input unit may be a touch sensor unit arranged on a screen of the display unit to be able to detect the handwriting input in response to a contact of an operation medium on the screen.

One or more embodiments of the invention relate to an information processing apparatus which includes: a touchscreen including a display unit and a touch sensor unit arranged on a screen of the display unit to detect a contact with an object on the screen; a memory that temporarily stores a program; and a processor connected to the touchscreen and configured to execute the program stored in the memory, wherein the processor executes the program stored in the memory to perform processing of: receiving, via the touch sensor unit of the touchscreen, an ink stroke on or near an existing handwritten text object already displayed on the display unit of the touchscreen; determining whether the ink stroke is a gesture stroke on the basis of comparison between size and position attributes of the ink stroke and size and position attributes of the handwritten text object; and, in response to the ink stroke being determined to be the gesture stroke, modifying the displayed handwritten text object on the basis of a gesture corresponding to the ink stroke.

One or more embodiments of the invention relate to a control method for an information processing apparatus including an input unit capable of detecting handwriting input and a display unit capable of displaying a trajectory of the handwriting input, wherein the control method includes: a display controlling step, performed by a display control unit, of displaying a trajectory of the handwriting input detected by the input unit on the display unit; a text recognizing step, performed by a text recognition unit, of recognizing text on the basis of the handwriting input detected by the input unit; and a character size estimating step, performed by a character size estimation unit, of obtaining a size of drawing of each character in the text, estimating a character size of the text intended by a user on the basis of information about a standard height of each character, and generating information indicating the character size and a drawing position.

The above-described embodiments of the present invention can properly grasp the character size and drawing position for free-size or free-position handwriting input.

### BRIEF DESCRIPTION OF THE DRAWINGS

FIG. 1 is an external view of an example of a tablet terminal according to an embodiment of the present invention;

FIG. 2 is a diagram illustrating an example of a main hardware configuration of the tablet terminal according to the present embodiment;

FIG. 3 is a block diagram illustrating an example of a functional configuration of the tablet terminal according to the present embodiment;

FIG. 4 is a diagram illustrating an example of information about the standard height of each character in the present embodiment;

FIGS. 5(a)-(b) are diagrams illustrating an outline of character size estimation processing in the present embodiment;

FIGS. 6(a)-(d) are diagrams illustrating a specific example of the character size estimation processing in the present embodiment;

FIGS. 7(a)-(d) are diagrams illustrating examples of a drawing gesture in the present embodiment;

FIGS. 8(a)-(b) are diagrams illustrating an example of a case of making a determination of being a drawing gesture in the present embodiment;

FIGS. 9(a)-(b) are diagrams illustrating an example of a case of not making a determination of being a drawing gesture in the present embodiment;

FIG. 10 is a flowchart illustrating an example of the operation of the tablet terminal according to the present embodiment; and

FIG. 11 is a flowchart illustrating an example of drawing gesture determination processing of the tablet terminal according to the present embodiment.

### DETAILED DESCRIPTION

The information processing apparatus and the control method according to an embodiment of the present invention will be described below with reference to the drawings.

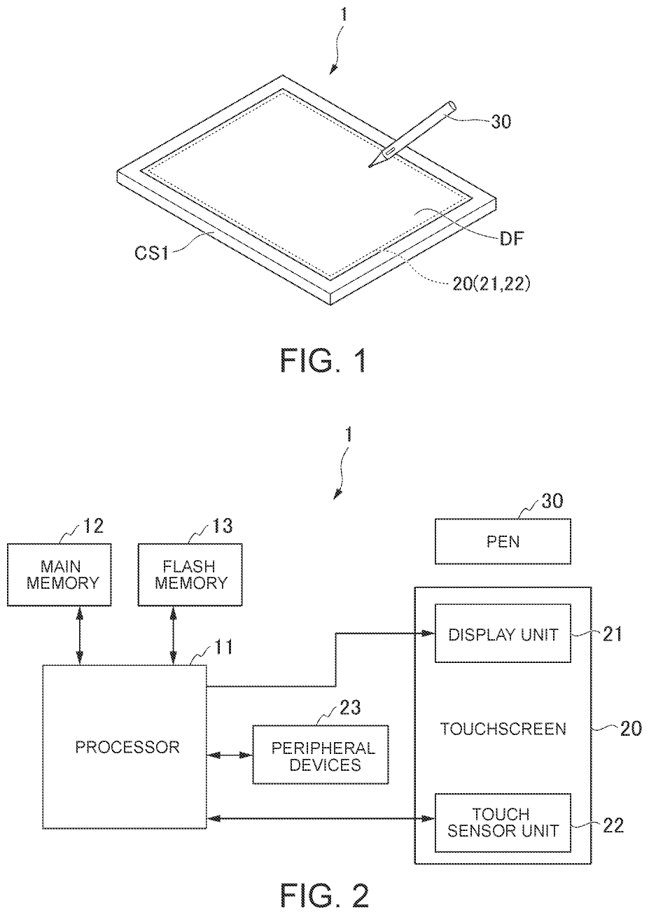

FIG. 1 is an external view of an example of a tablet terminal 1 according to the present embodiment. In the present embodiment, the tablet terminal 1 is described as an example of the information processing apparatus.

As illustrated in FIG. 1, the tablet terminal 1 has a touchscreen 20 provided on one main surface of a chassis CS1, and a pen 30 is used to execute, for example, a notepad or other application program.

The touchscreen 20 includes a display unit 21 and a touch sensor unit 22.

The touch sensor unit 22 is superimposed on the display unit 21, and detects the pen 30 contacting a display screen DF of the display unit 21 and also detects the contact position of the pen 30. The touch sensor unit 22 is capable of detecting a user's handwriting input with the pen 30.

In the present embodiment, the touch sensor unit 22 is an example of the input unit. The pen 30 is an example of the operation medium. The operation medium may be, besides the pen 30, a user's finger or the like.

The display unit 21, which is, for example, a liquid crystal display or an organic electro-luminescence (EL) display, displays various information on the display screen DF. The display unit 21 displays a display screen based on drawing data (display data) output from a processor 11. The display unit 21 is capable of displaying, for example, a trajectory of the handwriting input detected by the touch sensor unit 22.

In the present embodiment, handwriting input may also be referred to as an ink stroke.

A main hardware configuration of the tablet terminal 1 will now be described with reference to FIG. 2.

FIG. 2 illustrates an example of the main hardware configuration of the tablet terminal 1 according to the present embodiment.

As illustrated in FIG. 2, the tablet terminal 1 includes the processor 11, a main memory 12, a flash memory 13, the touchscreen 20, and peripheral devices 23.

The processor 11 is, for example, an application processor including a central processing unit (CPU). The processor 11 controls the entire tablet terminal 1.

The main memory 12 is a writable memory used as a reading area of programs executed by the processor 11 or as a working area for writing therein processing data of the programs. The main memory 12 is configured with, for example, a plurality of dynamic random access memory (DRAM) chips. The programs executed include an operating system (OS), various device drivers for controlling hardware of the peripherals, various services/utilities, application programs (application software), and the like.

The flash memory 13, which is, for example, a flash electrically erasable programmable read only memory (EEPROM), stores the OS, the various drivers, the various services/utilities, the application programs (hereinafter, also referred to as applications), and various data.

The peripheral devices 23 include, for example, a wireless local area network (WLAN) module, a Bluetooth (registered trademark) module, a global positioning system (GPS) module, and an acceleration sensor and other sensors.

The pen 30 is a pen-shaped operation medium, such as a touch pen, a stylus pen, or the like. The pen 30 may be, for example, an electronic pen equipped with a resonant circuit.

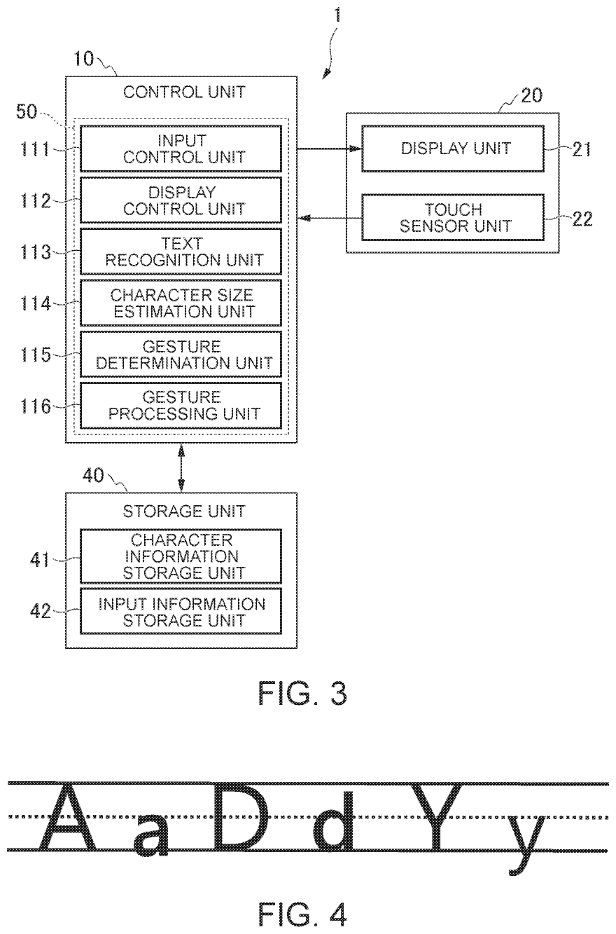

A functional configuration of the tablet terminal 1 according to the present embodiment will now be described with reference to FIG. 3.

FIG. 3 is a block diagram illustrating an example of the functional configuration of the tablet terminal 1 according to the present embodiment.

As illustrated in FIG. 3, the tablet terminal 1 includes a control unit 10, the touchscreen 20, and a storage unit 40.

The touchscreen 20 includes the display unit 21 and the touch sensor unit 22.

The storage unit 40, which is a storage unit implemented, for example, by the main memory 12 or the flash memory 13, includes a character information storage unit 41 and an input information storage unit 42.

The character information storage unit 41, which is a storage unit implemented, for example, by the main memory 12 or the flash memory 13, stores information about the size of each character used in the text. The character information storage unit 41 stores, for example, information indicating a standard positional relationship between each character and a baseline, cap line (upper limit line), and mean line, and the like.

Here, the baseline is a parallel line (horizontal line) that indicates the reference of characters, and the cap line is a parallel line (horizontal line) that indicates the upper limit position of uppercase alphabetic characters. The mean line, which is an intermediate line between the cap line and the baseline, is a parallel line (horizontal line) that indicates the upper limit position of lowercase alphabetic characters. The information indicating the positional relationship between each character and the baseline, cap line, and mean line is an example of the information about the standard height of each character. That is, the character information storage unit 41 stores the predetermined standard height information for each character. Here, an example of the information about the standard height of each character stored in the character information storage unit 41 will be described with reference to FIG. 4.

FIG. 4 illustrates an example of the information about the standard height of each character in the present embodiment.

As illustrated in FIG. 4, the information about the standard height of each character is information that indicates the relationship between the shapes of uppercase and lowercase versions of each character and the positions of baseline, cap line, and mean line. Here, the lower solid line is the baseline, the upper solid line is the cap line, and the middle dashed line is the mean line.

For example, the example illustrated in FIG. 4 indicates the relationship between the uppercase and lowercase character shapes of the characters “A”, “D”, and “Y” and the positions of the baseline, cap line, and mean line. For example, if a distance (x-height) between the mean line and the baseline for the lowercase character “a” is found, the information illustrated in FIG. 4 can be used to estimate a distance (cap height) between the cap line and the baseline, which indicates the character size.

Returning to the explanation of FIG. 3, the input information storage unit 42, which is a storage unit implemented, for example, by the main memory 12 or the flash memory 13, stores an input ink stroke (handwriting input) and its related information, metadata, in association with each other. Here, the ink stroke (handwriting input) is, for example, drawing data.

The metadata includes, for example, text data or drawn shape data (of, e.g., o (circle), Δ (triangle), □ (square) or the like) recognized from the ink stroke, information indicating the detected actual position and size, information indicating the estimated, user-intended position and size of the character or the shape, and the like. Here, the position is, for example, the position coordinates on the display screen DF of the display unit 21. The size is, for example, the size of text. Here, the text is, for example, a character string unit such as a word, a sentence, or the like, and the information indicating the position and size may be, for example, the position coordinates of the four corners of a rectangular (quadrilateral) area representing the character string and the height-direction size of the area.

The metadata may also include, as the information indicating the position and size, information indicating a range of text (also referred to as “text range”) (upper and lower lines (cap line and baseline) of user-intended character size) for use in determining a drawing gesture, which will be described later.

The control unit 10, which is a functional unit implemented, for example, by the processor 11 executing a program stored in the main memory 12 or the flash memory 13, performs various processing based on an OS (e.g., Android (registered trademark), or the like). The control unit 10 includes an input control unit 111, a display control unit 112, a text recognition unit 113, a character size estimation unit 114, a gesture determination unit 115, and a gesture processing unit 116.

The control unit 10 includes an application 50 that accepts handwriting input on, for example, a notepad for handwriting input or the like, and displays a trajectory of the accepted handwriting input on the display unit 21. The application 50 is a functional unit that is implemented by having the processor 11 execute an application program. The above-described input control unit 111, display control unit 112, text recognition unit 113, character size estimation unit 114, gesture determination unit 115, and gesture processing unit 116 are included in the application 50.

The input control unit 111, which is a functional unit implemented by the processor 11, controls input by the touch sensor unit 22, for example. The input control unit 111 obtains, from the touch sensor unit 22, an ink stroke (handwriting input) detected by the touch sensor unit 22, for example.

The display control unit 112, which is a functional unit implemented by the processor 11, displays on the display unit 21 a trajectory of the handwriting input detected by the touch sensor unit 22. That is, the display control unit 112 causes drawing data of the ink stroke obtained by the input control unit 111 to be displayed on the display unit 21.

Further, in the case where a drawing gesture (described later) is executed, the display control unit 112 performs a display modification after the editing processing according to the drawing gesture.

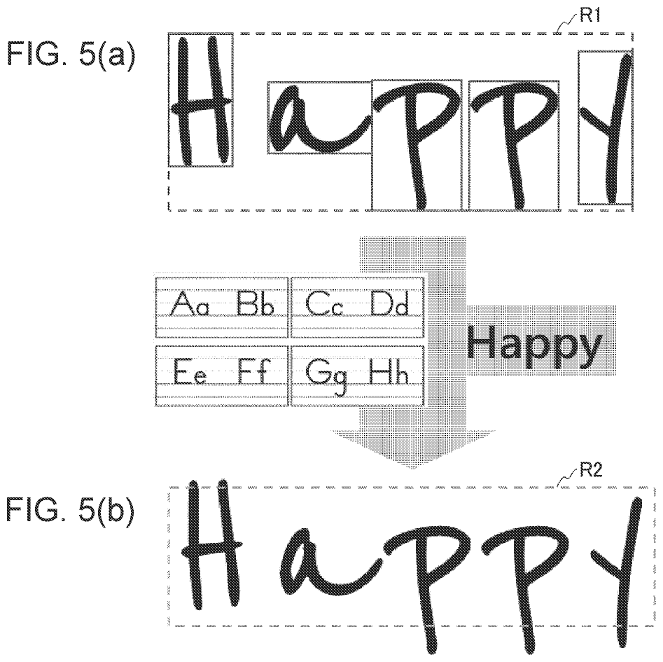

The text recognition unit 113, which is a functional unit implemented by the processor 11, recognizes text on the basis of the handwriting input detected by the touch sensor unit 22. The text recognition unit 113 recognizes the text from the ink strokes obtained by the input control unit 111 and generates text data. In the case where the touch sensor unit 22 detects ink strokes (handwriting input) as illustrated in FIG. 5(a), for example, the text recognition unit 113 generates text data of “Happy”, as illustrated in FIG. 5(b).

The character size estimation unit 114 is a functional unit implemented by the processor 11. The character size estimation unit 114 obtains the size of drawing of each character in the text, estimates the character size of the text intended by the user on the basis of the information about the standard height of each character, and generates information indicating the character size and drawing position. Here, the information about the standard height of each character is, for example, information that indicates the relationship between the shapes of the uppercase and lowercase versions of each character and the positions of the baseline, cap line, and mean line, as illustrated in FIG. 4. The character size estimation unit 114 estimates the user-intended character size of the text on the basis of the information, as illustrated in FIG. 4, stored in the character information storage unit 41.

Further, the character size estimation unit 114 sets the size of each character as an upper limit line (cap line) and a lower limit line (baseline), from the length in the height direction of each character of the text and from the positional relationship between the shape of each character and the baseline, cap line, and mean line. The character size estimation unit 114 sets an average line of upper limit of the character size of each character (an average line of the cap line) to the upper limit line, and sets an average line of lower limit of the character size of each character (an average line of the baseline) to the lower limit line. The character size estimation unit 114, on the basis of the upper and lower limit lines of the text, generates information indicating the user-intended character size of the text (information indicating the text range).

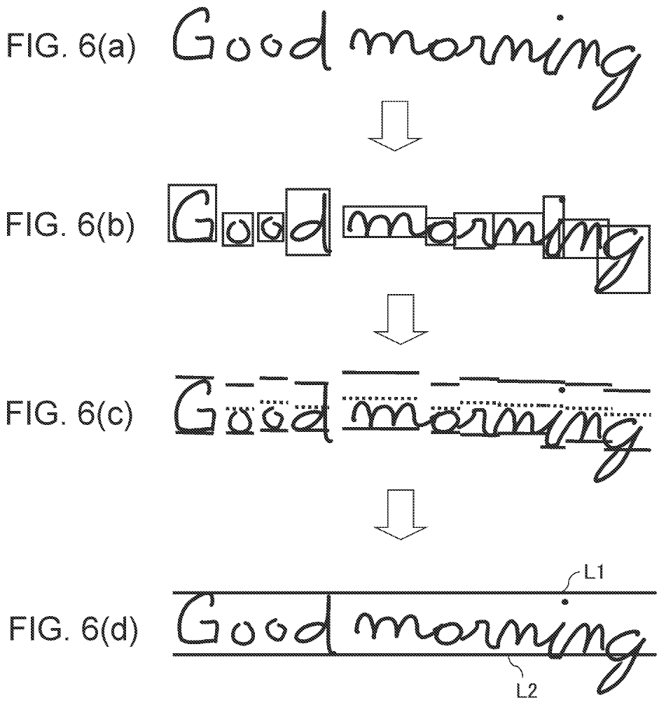

Character size estimation processing performed by the character size estimation unit 114 will now be described with reference to FIGS. 5 and 6.

FIG. 5 illustrates an outline of the character size estimation processing in the present embodiment.

When the touch sensor unit 22 detects ink strokes as illustrated in FIG. 5(a), the character size estimation unit 114 generates information such as a range R1, as information indicating the actual position and size detected.

Further, as illustrated in FIG. 5(b), the character size estimation unit 114 estimates the user-intended character size on the basis of the drawing data of the ink strokes, the text data “Happy” recognized by the text recognition unit 113, and the information stored in the character information storage unit 41. The character size estimation unit 114 generates information indicating the character size and drawing position, such as a range R2 illustrated in FIG. 5(b).

The character size estimation unit 114 stores, for example, the drawing data of the ink strokes, the text data (“Happy”), the information indicating the detected actual position and size (the information of the range R1), and the information indicating the user-intended character size and drawing position (the information of the range R2), in association with each other in the input information storage unit 42.

Details of the character size estimation processing performed by the character size estimation unit 114 will now be described with reference to FIG. 6.

FIG. 6 illustrates a specific example of the character size estimation processing in the present embodiment.

When the touch sensor unit 22 detects ink strokes as illustrated in FIG. 6(a), the character size estimation unit 114 obtains a drawing size of each character in the text, as illustrated in FIG. 6(b).

Next, on the basis of the information stored in the character information storage unit 41, the character size estimation unit 114 estimates the baseline, cap line, and mean line for each character, as illustrated in FIG. 6(c). Here, the solid lines indicate the baseline and the cap line, and the dashed line indicates the mean line.

Next, the character size estimation unit 114 generates an average line for each of the baselines and the cap lines of the characters, as illustrated in FIG. 6(d). That is, the character size estimation unit 114 generates an average line L1 of the cap lines on the upper side of the characters, as the upper limit line, and generates an average line L2 of the baselines on the lower side of the characters, as the lower limit line. Here, the upper limit line (average line L1) and the lower limit line (average line L2) are included in the text range, which is the information indicating the user-intended character size and drawing position.

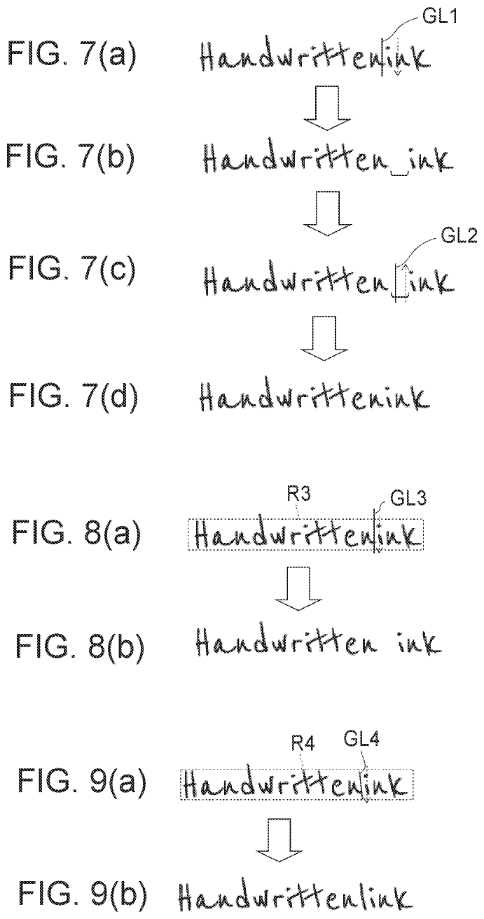

Returning again to the explanation of FIG. 3, the gesture determination unit 115 is a functional unit implemented by the processor 11. The gesture determination unit 115, on the basis of the text range set in accordance with the information indicating the character size and the drawing position generated by the character size estimation unit 114, determines that the trajectory of the handwriting input newly detected by the touch sensor unit 22 is a drawing gesture to edit the text. The drawing gesture according to the present embodiment will now be described with reference to FIG. 7.

A drawing gesture is an operation technique allowing a user to perform editing processing on drawn, handwritten text by making a specific handwriting input (ink stroke). The drawing gestures include, for example, “Break” to split text, “Join” to combine text, and the like.

FIG. 7 illustrates examples of the drawing gesture in the present embodiment. Here, the “Break” and “Join” drawing gestures are described.

In the present embodiment, a gesture to input by handwriting a vertical line of a specific length or longer from top to bottom on a character string of text, as illustrated in FIG. 7(a), is a “Break” drawing gesture. For example, in the “Break” drawing gesture, when a top-to-bottom vertical line GL1 is input on text “Handwrittenink” as illustrated in FIG. 7(a), the text is split into “Handwritten” and “ink”, as illustrated in FIG. 7(b).

Further, in a “Join” drawing gesture, when a vertical line GL2 from bottom to top is input between the split “Handwritten” and “ink” as illustrated in FIG. 7(c), the text becomes “Handwrittenink” with “Handwritten” and “ink” combined together, as illustrated in FIG. 7(d).

The gesture determination unit 115 determines the drawing gestures, such as “Break” and “Join” illustrated in FIG. 7, on the basis of the text range which is set in accordance with the information indicating the character size and drawing position generated by the character size estimation unit 114.

Specifically, in the case where a trajectory of newly detected handwriting input exceeds the set text range, for example, the gesture determination unit 115 determines that the trajectory of the newly detected handwriting input is a drawing gesture.

Further, in the case where a trajectory of newly detected handwriting input is within the set text range, for example, the gesture determination unit 115 determines that the trajectory of the newly detected handwriting input is a normal ink stroke (normal handwriting input).

Returning again to the explanation of FIG. 3, the gesture processing unit 116, which is a functional unit implemented by the processor 11, performs, on the text, editing processing according to the drawing gesture determined by the gesture determination unit 115. The gesture processing unit 116 performs command processing (gesture processing), which is the editing processing according to the drawing gesture.

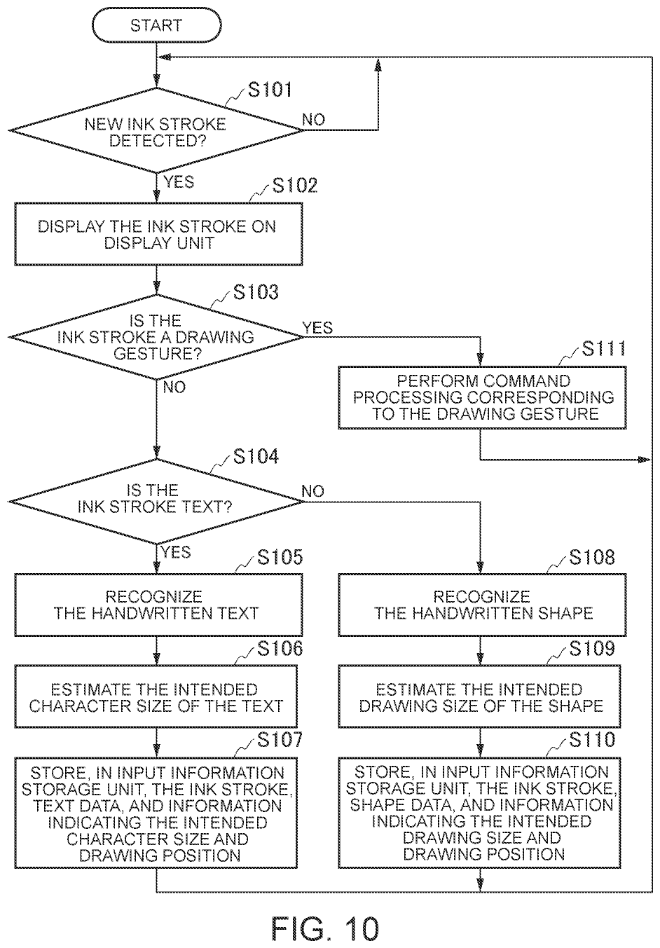

Performing the drawing gesture determination processing by the gesture determination unit 115 and the gesture processing by the gesture processing unit 116 will now be described with reference to FIGS. 8 and 9.

FIG. 8 illustrates an example of a case in which the gesture determination unit 115 in the present embodiment makes a determination of being a drawing gesture.

In FIG. 8(a), a text range R3, which is the text range set on the basis of the information indicating the character size and drawing position generated by the character size estimation unit 114, includes upper and lower limit lines in the vertical direction of the text.

When a top-to-bottom vertical line GL3 exceeding the text range R3 is input by handwriting, as illustrated in FIG. 8(a), the gesture determination unit 115 determines that it is a “Break” drawing gesture because the vertical line GL3 is exceeding the text range R3.

In this case, the gesture processing unit 116 performs, as the command processing of the “Break” drawing gesture, editing processing of splitting the text “Handwrittenink” into “Handwritten” and “ink”, as illustrated in FIG. 8(b).

FIG. 9 illustrates an example of a case in which the gesture determination unit 115 in the present embodiment does not make a determination of being a drawing gesture.

In FIG. 9(a), a text range R4, which is the text range set on the basis of the information indicating the character size and drawing position generated by the character size estimation unit 114, includes upper and lower limit lines in the vertical direction of the text.

When a top-to-bottom vertical line GL4 is input by handwriting within the text range R4, as illustrated in FIG. 9(a), the gesture determination unit 115 determines that it is not a “Break” drawing gesture because the vertical line GL4 falls within the text range R4.

In this case, the display control unit 112 adds a normal ink stroke drawing line for the vertical line GL4, and displays the text “Handwrittenlink”, as illustrated in FIG. 9(b).

An operation of the tablet terminal 1 according to the present embodiment will now be described with reference to the drawings.

FIG. 10 is a flowchart illustrating an example of the operation of the tablet terminal 1 according to the present embodiment.

As illustrated in FIG. 10, the tablet terminal 1 first determines whether a new ink stroke has been detected (step S101). The input control unit 111 of the tablet terminal 1 determines whether a new ink stroke (handwriting input) has been detected by the touch sensor unit 22. If the touch sensor unit 22 has detected a new ink stroke (YES in step S101), the input control unit 111 makes the process proceed to step S102. If the touch sensor unit 22 has not detected a new ink stroke (NO in step S101), the input control unit 111 makes the process return to step S102.

In step S102, the tablet terminal 1 displays the ink stroke on the display unit 21. That is, the display control unit 112 of the tablet terminal 1 obtains drawing data of the ink stroke detected by the touch sensor unit 22 and makes the drawing data of the ink stroke displayed on the display unit 21.

Next, the gesture determination unit 115 of the tablet terminal 1 determines whether the ink stroke is a drawing gesture (step S103). The gesture determination unit 115 determines whether the ink stroke is a drawing gesture or not, on the basis of the above-described text range and the shape of the ink stroke. If the ink stroke is a drawing gesture (YES in step S103), the gesture determination unit 115 makes the process proceed to step S111. If the ink stroke is not a drawing gesture (NO in step S103), the gesture determination unit 115 makes the process proceed to step S104.

In step S104, the text recognition unit 113 of the tablet terminal 1 determines whether the ink stroke is text. The text recognition unit 113 determines whether the ink stroke is text or not, in accordance with whether the ink stroke can be recognized as text such as a character. If the ink stroke is text (YES in step S104), the text recognition unit 113 makes the process proceed to step S105. If the ink stroke is not text (NO in step S104), the text recognition unit 113 makes the process proceed to step S108.

In step S105, the text recognition unit 113 recognizes the handwritten text. That is, the text recognition unit 113 recognizes text from the ink stroke, and generates text data.

Next, the character size estimation unit 114 of the tablet terminal 1 estimates an intended character size of the text (step S106). As illustrated in FIGS. 5 and 6 explained above, the character size estimation unit 114 estimates the user-intended character size of the text on the basis of the size of drawing of each character of the text and the information stored in the character information storage unit

Next, the character size estimation unit 114 stores the ink stroke, text data, and information indicating the intended character size and drawing position, in the input information storage unit 42 (step S107). For example, the character size estimation unit 114 stores, in the input information storage unit 42, the ink stroke and metadata (text data, information indicating the actual position and size, information indicating the estimated user-intended character position and size, and the like) in association with each other. Following the processing in step S107, the character size estimation unit 114 makes the process return to step S101.

In step S108, the text recognition unit 113 recognizes the handwritten shape. That is, the text recognition unit 113 recognizes, for example, a triangle, quadrangle, circle, or other shape from the ink stroke, and generates shape data (e.g., text data of the shape).

Next, the character size estimation unit 114 estimates an intended drawing size of the shape (step S109). As in the case of the text, the character size estimation unit 114 estimates the user-intended drawing size on the basis of the size of the drawing and the information stored in the character information storage unit 41 (e.g., shape information such as triangle, quadrangle, circle, and the like).

Next, the character size estimation unit 114 stores the ink stroke, shape data, and information indicating the intended drawing size and drawing position, in the input information storage unit 42 (step S110). For example, the character size estimation unit 114 stores, in the input information storage unit 42, the ink stroke and metadata (shape data, information indicating the actual position and size, information indicating the estimated user-intended drawing position and size, and the like) in association with each other. Following the processing in step S110, the character size estimation unit 114 makes the process return to step S101.

Further, in step S111, the gesture processing unit 116 of the tablet terminal 1 performs command processing corresponding to the drawing gesture. For example, the gesture processing unit 116 performs “Break” or “Join”, as illustrated in FIG. 7, or other editing processing. Following the processing in step S111, the process returns to step S101.

Details of the drawing gesture determination processing in step S103 in FIG. 10 will now be described.

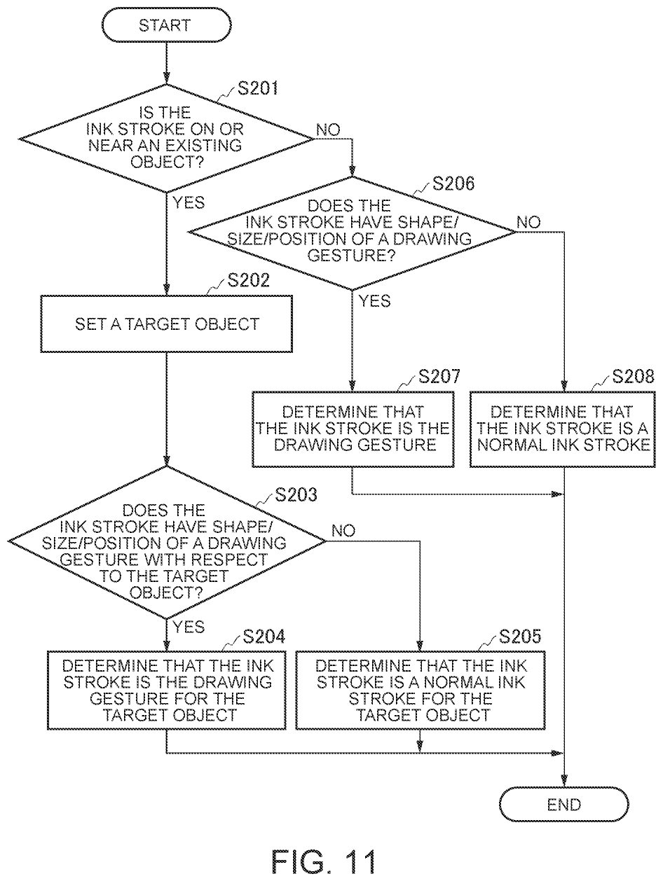

FIG. 11 is a flowchart illustrating an example of the drawing gesture determination processing in the tablet terminal 1 according to the present embodiment.

As illustrated in FIG. 11, the gesture determination unit 115 first determines whether the ink stroke is on or near an existing object (step S201). With text and/or drawing corresponding to the existing ink strokes stored in the input information storage unit 42 being regarded as objects, the gesture determination unit 115 determines whether the new ink stroke is on or near any object already displayed. First, if the ink stroke is on or near an existing object (YES in step S201), the gesture determination unit 115 makes the process proceed to step S202. First, if the ink stroke is not on or near an existing object (NO in step S201), the gesture determination unit 115 makes the process proceed to step S206.

In step S202, the gesture determination unit 115 sets a target object. The gesture determination unit 115 sets the object on or near which the ink stroke is to the target object, and obtains information corresponding to the target object from the input information storage unit 42.

Next, the gesture determination unit 115 determines whether the ink stroke has a shape/size/position of a drawing gesture with respect to the target object (step S203). The gesture determination unit 115 determines whether it has a shape/size/position of a drawing gesture on the basis of, for example, the text range which is the information indicating the user-intended drawing position and size stored in the input information storage unit 42. If the ink stroke has the shape/size/position of a drawing gesture with respect to the target object (YES in step S203), the gesture determination unit 115 makes the process proceed to step S204. If the ink stroke does not have the shape/size/position of a drawing gesture with respect to the target object (NO in step S203), the gesture determination unit 115 makes the process proceed to step S205.

In step S204, the gesture determination unit 115 determines that the ink stroke is a drawing gesture for the target object. That is, for example in such a case as illustrated in FIG. 8, the gesture determination unit 115 determines that the new ink stroke is a drawing gesture for the target object. In this case, the gesture determination unit 115 determines “YES” in step S103 in FIG. 10 explained above. Following the processing in step S204, the gesture determination unit 115 terminates (completes) the drawing gesture determination processing.

In step S205, the gesture determination unit 115 determines that the ink stroke is not a drawing gesture for the target object. That is, for example in such a case as illustrated in FIG. 9, the gesture determination unit 115 determines that the new ink stroke is not a drawing gesture for the target object. In this case, the gesture determination unit 115 determines “NO” in step S103 in FIG. 10 explained above. Following the processing in step S205, the gesture determination unit 115 terminates (completes) the drawing gesture determination processing.

Further, in step S206, the gesture determination unit 115 determines whether the ink stroke has the shape/size/position of a drawing gesture. Here, the gesture determination unit 115 determines whether the ink stroke alone corresponds to a drawing gesture. If the ink stroke has the shape/size/position of a drawing gesture (YES in step S206), the gesture determination unit 115 makes the process proceed to step S207. If the ink stroke does not have the shape/size/position of a drawing gesture (NO in step S206), the gesture determination unit 115 makes the process proceed to step S208.

In step S207, the gesture determination unit 115 determines that the ink stroke is a drawing gesture. In this case, the gesture determination unit 115 determines “YES” in step S103 in FIG. 10 explained above. Following the processing in step S207, the gesture determination unit 115 terminates (completes) the drawing gesture determination processing.

In step S208, the gesture determination unit 115 determines that the ink stroke is not a drawing gesture. In this case, the gesture determination unit 115 determines “NO” in step S103 in FIG. 10 explained above. Following the processing in step S208, the gesture determination unit 115 terminates (completes) the drawing gesture determination processing.

As such, the control unit 10 (processor 11) executes the program stored in the main memory 12 to perform the processing of determining whether the ink stroke is a gesture stroke (e.g., the drawing gesture) on the basis of comparison between the size and position attributes of the ink stroke (e.g., the information indicating the character size and drawing position) and the size and position attributes of the handwritten text object, and, if the ink stroke is determined to be a gesture stroke, the processing of modifying the displayed handwritten text object on the basis of the gesture corresponding to the ink stroke.

As described above, the tablet terminal 1 (information processing apparatus) according to the present embodiment includes the input unit, the display unit 21, the display control unit 112, the text recognition unit 113, and the character size estimation unit 114. Here, the input unit is, for example, the touch sensor unit 22 which is arranged on a screen of the display unit 21 to be able to detect handwriting input (an ink stroke) in response to a contact of an operation medium (e.g., the pen) on the screen. The touch sensor unit 22 is capable of detecting handwriting input. The display unit 21 is capable of displaying a trajectory of the handwriting input. The display control unit 112 displays a trajectory of the handwriting input detected by the touch sensor unit 22 on the display unit 21. The text recognition unit 113 recognizes text on the basis of the handwriting input detected by the touch sensor unit 22. The character size estimation unit 114 obtains a size of drawing of each character of the text, estimates a character size of the text intended by a user on the basis of information about a standard height of each character, and generates information indicating the character size and a drawing position (e.g., the text range corresponding to the user-intended character size).

Thus, the tablet terminal 1 according to the present embodiment generates the information indicating the character size and drawing position of the text intended by the user, so that the character size and drawing position can be properly grasped for free-size handwriting input. Therefore, the tablet terminal 1 according to the present embodiment eliminates the need to display ruled lines to limit the character size and drawing position, as in the conventional technology, and can appropriately support free-size or free-position handwriting input.

It should be noted that the tablet terminal 1 according to the present embodiment can, for example, understand the character structure after recognizing the characters and then use baseline information of the characters (e.g., the baseline, cap line, and mean line of each character) as a reference, so the intended position of each character can be grasped more accurately.

Further, the tablet terminal 1 according to the present embodiment includes the gesture determination unit 115 and the gesture processing unit 116. The gesture determination unit 115, on the basis of the text range set in accordance with the information indicating the character size and the drawing position generated by the character size estimation unit 114, determines that a trajectory of the handwriting input (ink stroke) newly detected by the touch sensor unit 22 is a drawing gesture to edit the text. The gesture processing unit 116 performs, on the text, editing processing according to the drawing gesture determined by the gesture determination unit 115 (see, for example, FIGS. 7 and 8).

Thus, the tablet terminal 1 according to the present embodiment can properly determine the drawing gesture for free-size handwriting input, and can appropriately perform editing processing according to the drawing gesture. For example, the tablet terminal 1 according to the present embodiment can appropriately perform the editing processing according to the drawing gestures as illustrated in FIGS. 7 and 8.

In the present embodiment, the gesture determination unit 115 determines that the trajectory of the newly detected handwriting input is the drawing gesture in the case where the trajectory of the newly detected handwriting input exceeds the text range (see, for example, FIG. 8).

Thus, the tablet terminal 1 according to the present embodiment can more properly determine a drawing gesture for the text, by using the text range for free-size handwriting input.

In the present embodiment, the text range includes upper and lower limit lines in the vertical direction of the text. The character size estimation unit 114 sets an average line of upper limit of the character size of each character to the upper limit line, and sets an average line of lower limit of the character size of each character to the lower limit line (see the average line L1 and the average line L2 in FIG. 6(d)).

Thus, the tablet terminal 1 according to the present embodiment can more properly determine the drawing gestures such as “Break” and “Join” illustrated in FIG. 7, for example.

It should be noted that if the text range is simply the range of the actually detected ink strokes, as in the range R1 in FIG. 5(a), the range will become large, thereby requiring a drawing gesture with larger ink stroke. In contrast, the tablet terminal 1 according to the present embodiment uses the average line of the upper limit and the average line of the lower limit of the character size of each character as the text range, as illustrated in FIG. 5(b), so a drawing gesture can be determined with a minimum-sized ink stroke.

Further, the tablet terminal 1 (information processing apparatus) according to the present embodiment includes the touchscreen 20, including the display unit 21 and the touch sensor unit 22 arranged on a screen of the display unit 21 to detect a contact with an object on the screen, the memory (e.g., the main memory 12) that temporarily stores a program, and the processor 11 connected to the touchscreen 20 and configured to execute the program stored in the memory. The processor 11 executes the program stored in the memory to perform processing of: receiving, via the touch sensor unit 22 of the touchscreen 20, an ink stroke on or near an existing handwritten text object already displayed on the display unit 21 of the touchscreen 20; determining whether the ink stroke is a gesture stroke (e.g., the drawing gesture) on the basis of comparison between size and position attributes of the ink stroke and size and position attributes of the handwritten text object; and, in response to the ink stroke being determined to be the gesture stroke, modifying the displayed handwritten text object on the basis of a gesture corresponding to the ink stroke.

Thus, the tablet terminal 1 according to the present embodiment can properly determine a gesture stroke (e.g., the drawing gesture) for free-size handwriting input, and can appropriately perform editing processing (processing of modifying the handwritten text object) according to the gesture stroke.

Further, the control method according to the present embodiment is a control method for the tablet terminal 1 including the touch sensor unit 22 capable of detecting handwriting input (an ink stroke) and the display unit 21 capable of displaying a trajectory of the handwriting input, and the method includes a display controlling step, a text recognizing step, and a character size estimating step. In the display controlling step, the display control unit 112 displays, on the display unit 21, a trajectory of the handwriting input detected by the touch sensor unit 22. In the text recognizing step, the text recognition unit 113 recognizes text on the basis of the handwriting input detected by the touch sensor unit 22. In the character size estimating step, the character size estimation unit 114 obtains a size of drawing of each character in the text, estimates a character size of the text intended by a user on the basis of the obtained size of drawing of each character in the text and information about a standard height of each character, and generates information indicating the character size and a drawing position (e.g., the text range).

Thus, the control method according to the present embodiment achieves similar effects as the tablet terminal 1 described above, and can properly grasp the character size and drawing position for free-size handwriting input.

The control method according to the present embodiment also includes a gesture determining step and a gesture processing step. In the gesture determining step, the gesture determination unit 115 determines that a trajectory of the handwriting input newly detected by the touch sensor unit 22 is a drawing gesture to edit the text, on the basis of the text range set in accordance with the information indicating the character size and drawing position generated in the character size estimating step. In the gesture processing step, the gesture processing unit 116 performs, on the text, editing processing according to the drawing gesture determined in the gesture determining step.

Further, the control method according to the present embodiment can properly determine a drawing gesture for free-size or free-position handwriting input, and can appropriately perform editing processing according to the drawing gesture.

Incidentally, a key technology in the drawing gesture technology is to accurately determine whether a trajectory of the pen given by handwriting to an apparatus such as the tablet terminal 1 is one that should be drawn or one that should be used for a drawing gesture. For example, in a case where a trajectory of the pen that the user moved with the intention of performing a drawing gesture is drawn, the convenience of the drawing gesture may be greatly impaired.

Conceivable techniques to determine a drawing gesture are generally as follows:

(1) A trajectory of a pen that cannot be in the drawing of a character is used as a gesture.

(2) A trajectory that is distinctively larger or smaller than the character to be drawn is used as a gesture.

In the technique of (2) above, the conventional technologies use a technique in which the size of characters that can be drawn by a user is designated in advance using ruled lines or the like displayed on the screen, to limit the assumed size of characters. In this case, by designating and fixing the assumed character size in advance, determination of the drawing gesture can be made easily and accurately.

However, with such conventional technologies, the size of characters that can correspond to drawing gestures is fixed to a pre-designated size, making it difficult to support handwriting input of free size and free position.

Furthermore, in such conventional technologies, the screen may be protected by a hard material, usually glass, to prevent abrasion caused by pen drawing, touch, and the like. In addition, to improve screen visibility, the protective surface has often undergone smoothing treatment. Therefore, drawing on such a hard and smooth surface causes more pen slippage than drawing on paper. In such a case, some drawing lines often extend longer than intended by the user. As a result, handwriting input results in characters that contain partially long drawn lines, and the size of the characters is significantly larger than intended by the user. When a drawing gesture is performed on such characters, it is difficult to accurately determine the drawing gesture using the determination method of the conventional technologies that is based on size determination.

In contrast, the tablet terminal 1 and the control method according to the present embodiment can accurately detect the size and drawing position of characters drawn by handwriting input of free size and free drawing position, thereby enabling more accurate detection of a drawing gesture performed on the characters drawn at free position and free size.

The tablet terminal 1 and the control method according to the present embodiment provides, in addition to the accurate detection of drawing gestures described above, a further effect of facilitating editing of handwritten characters. For example, in order to perform processing of adjusting the spacing of handwritten characters or aligning the vertical position of handwritten characters, it is necessary to accurately detect the size and drawing position of the handwritten characters in advance. With the tablet terminal 1 and the control method according to the present embodiment, such editing can also be performed more in line with the user's intentions.

It should be noted that the tablet terminal 1 (information processing apparatus) according to the present embodiment may be in the following form. The tablet terminal 1 (information processing apparatus) according to the present embodiment includes the touch sensor unit 22 (input unit) capable of detecting handwriting input, the display unit 21 capable of displaying a trajectory of the handwriting input, the main memory 12 (memory) that temporarily stores a program, and the processor 11 that executes the program stored in the main memory 12. The processor 11 performs display control processing, text recognition processing, and character size estimation processing. As the display control processing, the display control unit 112 displays on the display unit 21 a trajectory of the handwriting input detected by the touch sensor unit 22. As the text recognition processing, the text recognition unit 113 recognizes text on the basis of the handwriting input detected by the touch sensor unit 22. As the character size estimation processing, the character size estimation unit 114 obtains a size of drawing of each character in the text, estimates the character size of the text intended by a user on the basis of information about a standard height of each character, and generates information indicating the character size and a drawing position.

Thus, the tablet terminal 1 according to the present embodiment achieves similar effects as the control method described above, and can properly grasp the character size and drawing position for free-size handwriting input.

It should be noted that the present invention is not limited to the above embodiments, and can be modified within the range not departing from the spirit of the present invention.

For example, while the example in which the information processing apparatus is the tablet terminal 1 has been described in the above embodiment, the present invention is not limited thereto. The information processing apparatus may be, for example, a smartphone, a laptop personal computer equipped with a tablet mode, a desktop personal computer, or the like.

While the example in which the OS of the tablet terminal 1 is Android (registered trademark) has been described in the above embodiment, not limited thereto, it may be, for example, iOS (registered trademark), Windows (registered trademark), Linux (registered trademark), or other OS.

While the example in which the operation medium is a pen has been described in the above embodiment, not limited thereto, it may be the user's finger, an electronic pen, or other operation medium.

While the example in which the input unit is the touch sensor unit 22 has been described in the above embodiment, not limited thereto, it may be a mouse, touch pad, pointing stick, or other pointing device. The input unit may be any other input device as long as it is capable of handwriting input.

While the example in which the tablet terminal 1 uses the information indicating the character size and the drawing position generated by the character size estimation unit 114 for determining a drawing gesture has been described in the above embodiment, the present invention is not limited thereto. The information indicating the character size and the drawing position generated by the character size estimation unit 114 may be used in, for example, processing of breaking lines in digital text, processing of adjusting the size and arrangement of displayed characters, and the like.

In this case, the tablet terminal 1 may check the character size and drawing position for each word, and then perform the processing of adjusting the size and arrangement of the displayed characters by aligning the word positions. Alternatively, the tablet terminal 1 may check the character size and drawing position for each character, and then perform the processing of adjusting the size and arrangement of the displayed characters by aligning the word positions. When aligning the word positions, the tablet terminal 1 may, for example, align the word positions such that the baselines match, or align the word positions such that the half lines match.

While the example of using the average line of the upper limit and the average line of the lower limit of the character size of each character as the user-intended text range has been described in the above embodiment, not limited thereto, other parallel lines, such as parallel lines of the median, for example, may be used.

While the example of using the range surrounded by the parallel lines (horizontal lines) as the text range has been described in the above embodiment, not limited thereto, a range surrounded by other lines such as curved or diagonal lines may be used.

Further, while the example of performing the estimation of the character size of each character by using the baseline, cap line, and mean line as a reference has been described in the above embodiment, not limited thereto, a descender line, for example, which is a parallel line at the lowest point extending down from the baseline of a lowercase character, or the like may be used. Further, while the example of using the baseline as the lower limit line of character size has been described, the descender line may be applied to the lower limit line of character size. Furthermore, in the case where the character strings before and after the drawing gesture are lowercase characters, the mean line of the character strings before and after may be used as the upper limit line.

It should be noted that each configuration of the tablet terminal 1 described above internally includes a computer system. A program for implementing the functions of each configuration of the tablet terminal 1 described above may be recorded on a computer-readable recording medium, and the processing in each configuration of the tablet terminal 1 described above may be performed by having the computer system read and execute the program recorded on the recording medium. Here, “having the computer system read and execute the program recorded on the recording medium” includes installing the program in the computer system. As used herein, the “computer system” includes an OS and hardware such as peripherals.

The “computer system” may also include a plurality of computer apparatuses connected via a network, including the internet and communication lines such as WAN, LAN, and dedicated lines. The “computer-readable recording medium” is a portable medium, such as a flexible disk, a magneto-optical disk, a ROM, or a CD-ROM, as well as a storage device built in the computer system, such as a hard disk. As such, the recording medium storing the program may be a CD-ROM or other non-transient recording medium.

The recording medium also includes an internally or externally provided recording medium to which a distribution server can access to distribute the program. It should be noted that the program may be divided into a plurality of pieces, which may be downloaded at different timings and then combined together by each configuration of the tablet terminal 1, or different distribution servers may distribute the divided pieces of program. Furthermore, the “computer-readable recording medium” also includes a medium that holds a program for a certain period of time, such as a volatile memory (RAM) in a computer system serving as a server or a client when the program is transmitted via a network. The program may implement a part of the functions described above. Further, the program may be a so-called differential file (differential program) that can implement the above-described functions in combination with a program already recorded in the computer system.

Further, a part or all of the above-described functions may be implemented as a large scale integration (LSI) or other integrated circuit. Each of the functions described above may be individually implemented as a processor, or a part or all of the functions may be implemented as a processor in an integrated manner. A technique for integrated circuit is not limited to the LSI, and an integrated circuit may be implemented using a dedicated circuit or a general-purpose processor. If a technology for integrated circuit that replaces LSIs becomes available with the advancement of semiconductor technologies, an integrated circuit based on such a technology may be used.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SYMBOLS

1 tablet terminal

10 control unit

11 processor

12 main memory

13 flash memory

20 touchscreen

21 display unit

22 touch sensor unit

23 peripheral devices

30 pen

40 storage unit

41 character information storage unit

42 input information storage unit

50 application

111 input control unit

112 display control unit

113 text recognition unit

114 character size estimation unit

115 gesture determination unit

116 gesture processing unit

1. An information processing apparatus comprising:
an input unit capable of detecting handwriting input;
a display unit capable of displaying a trajectory of the handwriting input;
a display control unit configured to display a trajectory of the handwriting input detected by the input unit on the display unit;
a text recognition unit configured to recognize text based on the handwriting input detected by the input unit; and
a character size estimation unit configured to obtain a size of drawing of each character in the text, estimate a character size of the text intended by a user based on information about a standard height of each character, and generate information indicating the character size and a drawing position.

2. The information processing apparatus according to claim 1, further comprising:
a gesture determination unit configured to determine that a trajectory of the handwriting input newly detected by the input unit is a drawing gesture to edit the text, based on a range of the text set in accordance with the information indicating the character size and the drawing position generated by the character size estimation unit; and
a gesture processing unit configured to perform, on the text, editing processing according to the drawing gesture determined by the gesture determination unit.

3. The information processing apparatus according to claim 2, wherein the gesture determination unit determines that the trajectory of the newly detected handwriting input is the drawing gesture in response to the trajectory of the newly detected handwriting input exceeding the range of the text.

4. The information processing apparatus according to claim 2, wherein the range of the text includes an upper limit line and a lower limit line in a vertical direction of the text.

5. The information processing apparatus according to claim 4, wherein the character size estimation unit sets an average line of upper limit of the character size of each character to the upper limit line, and sets an average line of lower limit of the character size of each character to the lower limit line.

6. The information processing apparatus according to claim 1, wherein the input unit is a touch sensor unit disposed on a screen of the display unit to be able to detect the handwriting input in response to a contact of an operation medium on the screen.

7. An information processing apparatus comprising:
a touchscreen including a display unit and a touch sensor unit disposed on a screen of the display unit to detect a contact with an object on the screen;
a memory that temporarily stores a program; and
a processor connected to the touchscreen and configured to execute the program stored in the memory,
wherein the processor executes the program stored in the memory to perform processing of
receiving, via the touch sensor unit of the touchscreen, an ink stroke on or near an existing handwritten text object already displayed on the display unit of the touchscreen,
determining whether the ink stroke is a gesture stroke based on comparison between size and position attributes of the ink stroke and size and position attributes of the handwritten text object, and
in response to the ink stroke being determined to be the gesture stroke, modifying the displayed handwritten text object based on a gesture corresponding to the ink stroke.

8. A control method for an information processing apparatus including an input unit capable of detecting handwriting input and a display unit capable of displaying a trajectory of the handwriting input, the control method comprising:
a display controlling step, performed by a display control unit, of displaying a trajectory of the handwriting input detected by the input unit on the display unit;
a text recognizing step, performed by a text recognition unit, of recognizing text based on the handwriting input detected by the input unit; and
a character size estimating step, performed by a character size estimation unit, of obtaining a size of drawing of each character in the text, estimating a character size of the text intended by a user based on information about a standard height of each character, and generating information indicating the character size and a drawing position.
